(19) United States
(12) Patent Application Publication
(10) Pub. No.: US 2026/0227767 A1
(43) Pub. Date: Aug. 6, 2026

(54) SYSTEMS AND METHODS OF CONTROLLING PRODUCTION LINES OF A PRODUCTION ASSEMBLY FACILITY

(71) Applicant: Walmart Apollo, LLC, Bentonville, AR (US)

(72) Inventors: Parthasarathy Ramamoorthy, Bentonville, AR (US); Rama Durga Sekhar Angadala, Bentonville, AR (US); Jeffin V. Jacob, Centerton, AR (US); Parth Dhir, Bengaluru (IN); Devanand Chintoju, Hyderabad (IN); Rahul Ghosh, Bangalore (IN); Joel A. Rutledge, Bentonville, AR (US); Martin V. Tabler, Rogers, AR (US); Rajesh Gundapaneni, Bentonville, AR (US)

(21) Appl. No.: 19/042,376

(22) Filed: Jan. 31, 2025

(51) Int. Cl. G05B 19/418

(52) U.S. Cl. CPC G05B 19/41865; G05B 2219/32252

(57) ABSTRACT

Some embodiments provide systems to control a production facility according to a production schedule comprising: a processing resource; a non-transitory machine readable medium storing executable instructions that, when executed, cause the processing resource to: generate, using a first trained model, sets of forecasted production optimizations of the multiple production lines using predicted product demand and production line data, relative to multiple objective constraints comprising production line change over time, a maximum uptime limit, and production line utilization; generate, using a second trained model and the sets of forecasted production optimizations, a first production schedule of the multiple production lines while complying with the multiple objective constraints; and control one or more system components of the multiple production lines consistent with the first production schedule to implement production of a respective one of the multiple different products.

### TECHNICAL FIELD

This disclosure relates generally to controlling production lines of manufacturing facilities.

### BACKGROUND

The manufacturing or production of products is a complex process. Large scale production facilities are complex and require extensive control. There is a need to improve the operational control of many production facilities.

### BRIEF DESCRIPTION OF DRAWINGS

Disclosed herein are embodiments of systems, apparatuses and methods pertaining to controlling production lines of manufacturing facilities. This description includes drawings, wherein:

FIG. 1 illustrates a block diagram of an example production facility control system, in accordance with some embodiments.

FIG. 2 illustrates a functional block diagram of an example facility control system, in accordance with some embodiments.

FIG. 3 illustrates a flow diagram of an example process of controlling a production facility in producing products via multiple production lines in controlling a production facility in producing multiple different products along multiple production lines, in accordance with some embodiments.

FIG. 4 depicts an example system that includes one or more non-transitory, machine readable media encoded with example instructions executable by one or more processing resources, in accordance with some embodiments.

FIG. 5 depicts an example system that includes one or more non-transitory, machine readable media encoded with example instructions executable by one or more processing resources, in accordance with some embodiments.

FIG. 6 illustrates a functional diagram of an example semi-final goods scheduling process, in accordance with some embodiments.

FIG. 7 illustrates an example system for use in implementing methods, techniques, devices, apparatuses, systems, servers, sources and providing scheduling and control of production lines in the production of products, in accordance with some embodiments.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments. Also, common but well-understood elements that are useful or necessary in a commercially feasible embodiment are often not depicted in order to facilitate a less obstructed view of these various embodiments. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

The following description is not to be taken in a limiting sense, but is made merely for the purpose of describing the general principles of example embodiments. Reference throughout this specification to “one embodiment,” “an embodiment,” “some embodiments”, “an implementation”, “some implementations”, “some applications”, or similar language means that a particular feature, structure, or characteristic described in connection with the embodiment is included in but is not limited to at least one embodiment of the disclosure. Thus, appearances of the phrases “in one embodiment,” “in an embodiment,” “in some embodiments”, “in some implementations”, and similar language throughout this specification may, but do not necessarily, all refer to the same embodiment.

Present embodiments provide systems and methods that control multiple production lines of a production and/or manufacturing facility to implement comprehensive optimized planning and procurement scheduling in the production of multiple different products through the multiple production lines. The comprehensive planning and procurement scheduling is developed to provide, in some embodiments, end-to-end optimal scheduling for finished goods (FG), taking into consideration semi-finished goods (SFG), raw product(s), and/or raw production materials (RM). Further, the scheduling can attempt to maximize line utilization, SFG usage, meeting inventory targets, and satisfying demand. The scheduling provides advanced planning and visibility spanning multiple product cycles, such as over multiple days and weeks, and serves as a valuable resource for both facility operators (e.g., for FG and SFG schedules) and the control of procurement (e.g., with RM schedule). The control of the production line according to the comprehensive production scheduling decreases a cost-per-unit, and enhances productivity, thereby leading to significant cost savings.

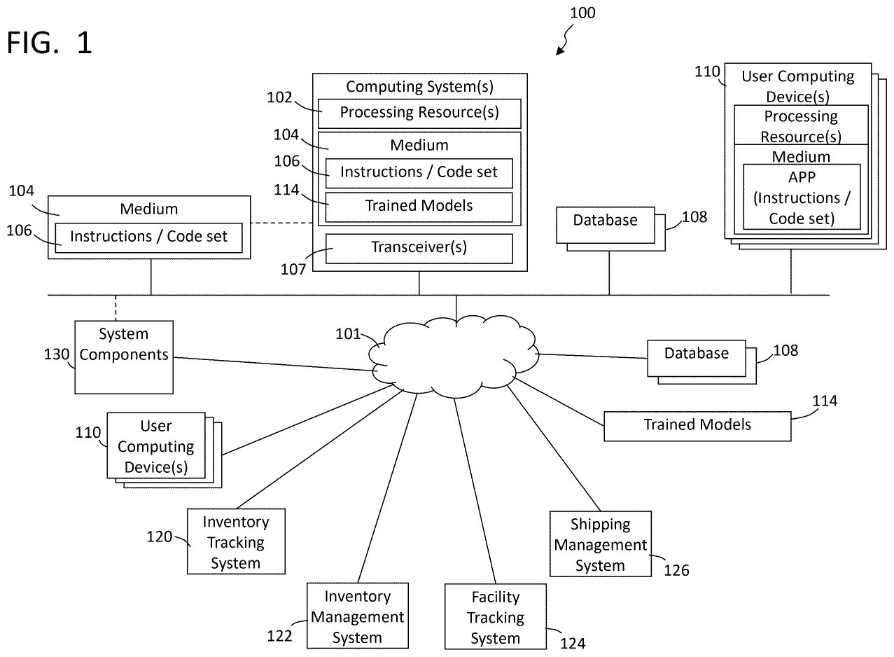

FIG. 1 illustrates a block diagram of an example production facility control system 100, in accordance with some embodiments, that can control the operations of one or more production lines at one or more production facilities. The production facility control system 100 can include one or more electronic processing resources 102 that may include one or more microcontrollers, one or more microprocessors, one or more central processing unit cores, one or more application-specific integrated circuits (ASIC), one or more servers, one or more field programmable gate arrays (FPGA), control logic, other such systems or a combination of two or more of such systems. The facility control system 100 further includes a machine readable medium 104 that may be non-transitory and include for example one or more random access memory (RAM), one or more read-only memory (ROM), one or more electrically erasable programmable read-only memory (EEPROM), one or more flash memory, one or more hard disk drives, other such mediums, or a combination of two or more of such mediums. Some or all of the medium 104 include one or more databases accessible via the network 101 that maintains and stores relevant data. Further, the medium 104 may be part of the processing resource, external to and accessible to the processing resource 102, or a combination of internal and external mediums. Additionally, one or more mediums may be remote and provide distributed and/or redundant storage. The one or more distributed networks 101 can be substantially any relevant wired and/or wireless computer and/or communications networks (one or more local area networks (LAN), one or more wireless area networks (WAN), one or more other wireless networks (e.g., cellular, Wi-Fi, Bluetooth, LoRa, LoRa-WAN, etc.), other such networks, or a combination of two or more of such networks).

The processing resource 102 may execute instructions 106 (e.g., programming and/or one or more software sets of code) stored on machine readable medium 104 that when executed by processing resource 102 causes the processing resource to perform functions of the facility control system 100. Additionally or alternatively, the processing resource 102 may include electronic circuitry for performing some or all of the functionality described herein. The facility control system 100 may also include other hardware components, such as physical storage (e.g., hard disk drive, a solid state drive, or the like, or a plurality of such storage devices (e.g., an array of disks)), and may be locally attached (i.e., installed) in the facility control system 100. In some implementations, physical storage may be accessed as a block storage device. The processing resource is communicatively coupled with and/or controls one or more wired and/or wireless data communications transceivers 107, transmitters and/or receivers that communicatively coupled with the one or more distributed communications networks 101. The processing resource 102 controls communications from and/or to the processing resource, and/or from and/or to the facility control system 100, to communicate instructions and/or commands, manage data distribution, retrieve information, receive commands and/or instructions, communicate status information, and/or other such communications.

The facility control system 100 includes and/or is in communication with one or more internal and/or external databases 108 that can store data for use by the processing resource 102, other local systems and/or remote systems. Further, the databases may be part of the processing resource 102, the medium 104 and/or one or more separate mediums. The facility control system 100 typically further includes and/or is accessible by numerous user computing devices 110 (e.g., computer, laptop, tablet, smartphone, user wearable system, etc.) that are used by users to acquire information regarding the implementation of processing line control and/or providing information and/or instructions.

In some embodiments, the facility control system 100 can include, be a part of and/or can be communicatively coupled with one or more retail entities, one or more entities that provide raw product(s), raw production material(s), shipping entities, and/or other such entities. The facility control system 100 may be part of a retail entity that distributes and sells product produced through the one or ore production facilities. As such, the facility control system 100 can include and/or be communicatively coupled with an inventory tracking system 120 that can track inventory within the production facility, expected to be received at the facility and/or distributed and/or sold from the facility, inventory management system 122 that can track inventory of raw product(s), production material(s), finished goods (FG), semi-finished goods (SFG), and/or other such inventory information, a facility tracking system 124 may further track line utilization of the multiple production lines of one or more production facilities, track semi-finished goods (SFG) usage, product demand, and/or other such information, a shipping management system 126 that can manage the distribution of products from a facility and/or to a facility (e.g., manage shipping to customers), other such systems, and typically a combination of two or more of such systems.

The facility control system 100, in part generates optimized scheduling of the operation of the production lines of the one or more production facilities, and in some embodiments can manage and/or control acquisition of raw product(s), production material(s), can control the operation of one or more components (e.g., pumps, conveyor systems, transport systems, loading systems, heating and/or cooling systems, and/or other such components), and/or issues instructions for the implementation of one or more tasks (e.g., loading production materials, moving finished goods, preparing for shipment, etc.). The processing resource 102 is configured to access and/or receive information about the status of operation of the one or more production lines, the inventory of raw product(s), the inventory of production materials, the inventory of semi-finished goods, the inventory of finished goods, orders from retail entities, distribution, historic operating levels, historic demand, historic orders, historic production material use, and other such information.

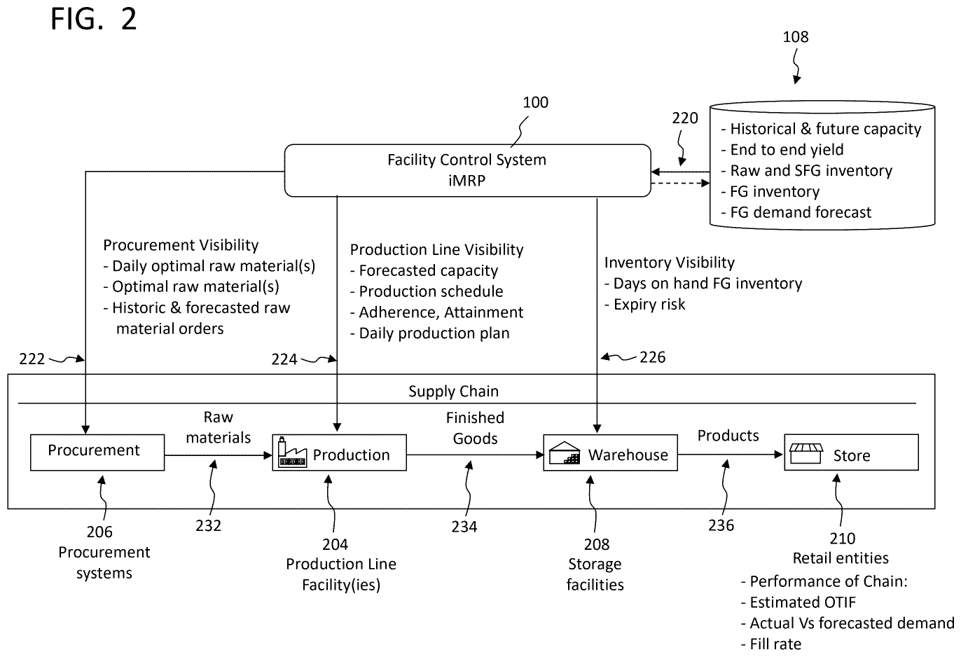

FIG. 2 illustrates a functional block diagram of an example facility control system 100, in accordance with some embodiments, in communication with one or more databases and/or other data sources 108 of input information, one or more production facilities 204 with one or more production lines, one or more procurement systems 206, one or more product storage facilities 208 (e.g., warehouse, retail store, distribution center, shipping facility, etc.), and one or more retail facilities 210 and/or other entities acquiring products 236 produced at the production facility 204 controlled in part through the facility control system 100. Referring to FIGS. 1-2, processing resource 102, in executing instructions, accesses 220 operational data maintained in one or more databases 108 and/or other data storage sources and/or systems. In some embodiments, the processing resource 102 can execute a multi-layer production scheduling operation of multiple production lines of one or more production facilities 204 to produce products. Each production line can be implemented to produce at least one and typically multiple different products 236. The multi-layer production scheduling uses multiple layers of machine learning models to generate an optimized schedule.

In implementing the multi-layer production scheduling, in some embodiments, the processing resource can generate, using a set of one or more first trained models 114 and/or algorithms (e.g., multi-objective optimization algorithms, Non-Dominated Sorting Genetic algorithms Ill (NSGA-Ill), etc.), multiple sets of forecasted production optimizations each corresponding to at least one of the multiple production lines in producing the multiple different products 236. The first set of one or more trained models 114 access one or more data sources (e.g., databases 108) of historic data and current data. For example, the data used by the one or more first trained models can include predicted product demand and production line data, relative to multiple objective constraints. The constraints dictate at least some operating restrictions and/or conditions that are to be met in the operation of one or more of the production lines. The first trained model is trained using a corpus of data regarding historic production optimizations, historic product demand, historic production line data, historic objective constraints, historic production facility operating schedules, historic production rates, other such information, and typically a combination of two or more of such information. The first trained model 114 is further repeatedly retrained over time using feedback information (e.g., produced production optimizations, modifications implemented by one or more users, margins of error, resulting production rates, resulting historic production facility operating schedules, historic production rates based on generated schedules, other such data, and typically a combination of two or more of such data). The retraining produces new or modified trained set of one or more first models that are predicted to provide more accurate results.

Further, a second layer of the multi-production scheduling can be implemented with the processing resource 102 generating, using a set of one or more second trained models 114 and/or algorithms (e.g., simulated annealing algorithms, Meta-Heuristics algorithms, and/or other such algorithms) that use the generated sets of forecasted production optimizations, at least one production schedule of the multiple production lines over a scheduled period of time, which in some implementations comprises multiple production days. In some embodiments, multiple different potential production schedules are generated and one of the potential production schedules can be selected, as described below. The second trained model is trained using a corpus of data regarding historic production facility operating schedules, historic production facility operating timing, historic product yields, historic raw product inventory data, historic semi-finished goods data, historic demand, historic production rates, historic purchase orders, other such information, and typically a combination of two or more of such information. The second trained model is further repeatedly retrained over time using feedback information (e.g., produced production schedules, schedule modifications implemented by one or more users, margins of error, resulting production rates, resulting yields, semi-finished goods utilization quantities and/or rates, expiration of product quantities and/or rates, compliance rates, direct user feedback, changes to production schedules, changes to inventory information, other such data, and typically a combination of two or more of such data). The retraining produces new or modified trained set of one or more second models that are predicted to provide more accurate results.

The production schedule when implemented at the one or more production facilities 204 controls the production lines in producing the multiple different products 234 as a function of the predicted product demand of the multiple different products while complying with the multiple objective constraints. In some embodiments, the facility control system 100 in generating the production scheduling can further provide procurement data 222 (e.g., daily optimal raw materials 232, optimal raw materials, forecasted raw materials order, etc.) that can be used by a procurement system 206. Further, the facility control system 100 in some embodiments generates a procurement schedule (e.g., raw product scheduling) that can be used to control the procurement of raw products, production materials (e.g., labels, bottles, containers, etc.), and/or other such materials to be utilized in the production of intended products 234. The raw materials and/or other materials 232 are utilized in the production facility 204 when implementing the generated production schedule to control the multiple production lines in producing the one or more products 234. Production line data 224 can be provided to the production facility 204 for use in controlling the production (e.g., forecasted capacity, production schedule, adherence data, attainment data, daily production plan data, etc.). In some embodiments, some or all of the products 234 can be maintained in a storage facility 208 and/or shipped 236 to one or more retail stores 210, customers, and/or other entities. The storage facilities may be provided with storage data 226, such as days on hand finished goods inventory data, expiry data, and/or other such data.

The objective constraints may be specific for a particular production line based on the specific product to be produced, general operating constraints, governmental constraints, and/or other constraints. For example, objective constraints can include but are not limited to production line change over time, a maximum uptime limit for each of the multiple production lines, and production line utilization. One or more additional or alternative objective constraints may be used as a function of the product being produced and/or the production line being utilized. For example, other objective constraints can include usage of semi-finished goods, quantities of finished goods of one or more products, predicted and/or available production line operating durations, uptime or operating time limits of the production lines, compliance with one or more governmental regulations, inventory targets, stock levels, demand, and/or other such constraints. These constraints in part dictating limits on the operation of the different production lines and the ability to use the production lines. Similarly, these constraints attempt to direct an optimum utilization of available materials and resources in the overall production of finished goods.

The production line change over time can define a time it takes to switch a production line from producing a first product to be able to produce a second product. As non-limiting examples, a production facility may produce different milk products (e.g., whole milk gallon product, 2% milk gallon product, 1% milk gallon product, whole milk half-gallon product, 2% milk half-gallon product, 1% milk half-gallon product, chocolate milk half-gallon product, etc.), with at least one line of the multiple production lines capable of producing two or more of the different milk products, with the production line change over time defining an allocated or estimated duration of time needed to adjust a first production line from producing a first milk product (e.g., whole milk gallon products) to a second milk product (e.g., whole milk half-gallon products). This change over can include, for example, changing one or more supplies of one or more raw products (e.g., source milk), switching to different production materials (e.g., bottles, caps, lids, labels, boxes, containers, etc.), and/or other such adjustments of a production line in order to effectively produce the second product.

In complying with the constraints in optimizing the scheduling of production lines, the processing resource, using the first trained model, can apply sets of objective constraints such as minimizing the production line change over times, maximizing uptime limits for each of the multiple production lines, maximizing the production line utilization of the multiple production lines, and maximize semi-finished goods usage. Additionally or alternatively, in some embodiments, the application of the first trained model can provide a prioritization based on quantities of finished goods. The processing resource can generate the sets of forecasted production optimizations of the multiple production lines, using the first trained model, to comply with a scheduling constraint to scheduling production of a first product, of the multiple different products, that has a lower quantity of finished goods to a production period of time of a daily production line operating duration that is subsequent to a scheduled production period of a second product of the multiple different products that has a second quantity of finished goods that is greater than the lower quantity of finished goods of the first product.

Similarly, the processing resource, in generating the sets of forecasted production optimizations of the multiple production lines, can use the first trained model relative to a constraint of risks of expiration of previously produced and stored finished products of one or more of the multiple different products. Many production facilities fail to take into consideration an expiration factor. By utilizing an expiration constraint of products already produced, the processing resource can priority scheduling of the production lines and/or the distribution of finished goods to limit or avoid products expiring.

The sets of forecasted production optimizations can, in some embodiments, be generated using the first trained model relative to complying with government regulations, which can include uptime operating limits of each of the multiple production lines. In some industries, there may be governmental regulations about limits on how long a production line can be operated, such as based cleaning schedules, work hour limits, and/or other such restrictions. For example, in some locations, there may be government regulations that set limits on how long a dairy production line producing one or more milk products can remain active. Some embodiments, for example, utilize a cycle uptime limit per production line with each production line in a dairy production facility runs in time duration cycles, which can depend on a type of milk product being produced. In some instances, for example, governmental constraints may dictate a maximum uptime line of a first production line producing a first milk product (e.g., whole milk gallon product) of 36 hours before a cleaning is required, a second production line producing a second milk product (e.g., 2% milk gallon product) of 36 hours before a cleaning is required, and a first production line producing a third milk product (e.g., chocolate milk half-gallon product) of 24 hours before a cleaning is required, which provide a set of 36, 36, 24 hours uptime limit constraints for production lines P1, P2 and P3 at a dairy production facility. In some embodiments, the uptime is defined as total hours a line is running continuously without any significant downtime. Further, in some embodiments, the sets of forecasted production optimizations are generated with the first trained model being applied additionally durations of cleaning times during which one or more production lines are not producing. Such cleaning times might include, for example, cleaning-in place (CIP) cleaning that takes place, such as, when switching between two different types of products (e.g., transition from high fat milk finished goods, to a low fat milk finished; transition from a chocolate milk finished good to a non-chocolate milk finished good, etc.), and/or when the line uptime reaches a cycle uptime limit (e.g., governmental limit); a master sanitation schedule (MSS) that is implemented to perform a deep cleaning of one or more production lines (e.g., deep cleaning that occurs every X days on each of the production lines); and/or other such cleaning down times. Other down times can similarly be utilized by the first trained model, such as planned down times (e.g., maintenance down time, planned idle down times (e.g., one or more lines and/or a facility is not operating), general down times, and/or other such potential down times), estimated unplanned downtimes and/or other such potential downtimes.

Further embodiments apply constraints related to predicted inventory and/or ending inventory following a production run of a product, a target stock level, demand, and/or other such constraints. For example, in some embodiments, the sets of forecasted production optimizations are generated using the first trained model in compliance with maximizing an ending inventory to a target stock level ratio, maximizing semi-finished goods usage, and minimizing the production line change over time.

In some embodiments, the processing resource, utilizing of the set of one or more second trained models 114, generates multiple different potential production schedules each corresponding to the multiple production lines over the scheduled period of time. These multiple different potential production schedules can be further evaluated to select one of the potential production schedules as the production schedule to be implemented in controlling the production facility. The processing resource 102, in some embodiments, executes a sequencing code set 106 causing the processing resource to apply one or more weightings to the multiple potential production schedules as a function of expected compliance with one or more constraints. For example, in some embodiments, the processing resource can apply a first variable weightings to target changeover time of a first production line of the multiple production lines in combination with second variable weightings to semi-finished goods usage. Other weightings and/or combinations of weightings relative to constraints can be applied. Based on the weighted evaluation, a first production schedule, of the multiple potential production schedules, as a function of the one or more variable weightings (e.g., the first variable weightings and the second variable weightings). In some embodiments, the processing resource can, in a post-processing layer, evaluate the multiple potential production schedule solutions, and identify one of the potential production schedules based on for example weighted average of the objective constraints (e.g., for e.g., Day 1: 70% weightage to a target deviation, 2% weightage to changeover and cleaning time constraint, 7% weightage to each line utilization constraint, 7% weightage to SFG usage constraint).

The processing resource 102, in some embodiments, can execute a raw product scheduling code set to use the selected first production schedule to schedule variable deliveries of one or more raw product (e.g., raw milk for a milk products production facility, raw wood for a production facility utilizing wood in producing a product, quantity(ies) of aluminum for a production facility utilizing aluminum in producing a product, etc.) used to produce at least a first product of the multiple different products, over the scheduled period of time to satisfy the first production schedule. This raw product scheduling is often critical to ensure sufficient quantities of raw product to produce the intended products at the scheduled production quantities and/or levels dictated by the first production schedule, which again is generated to comply with the multiple constraints including demand. The execution of the raw product scheduling code can further take into consideration finished goods on hand, semi-finished goods, already available raw products, and/or other such information in determining quantities of the raw product to schedule. Still further, the processing resource, executing the raw product scheduling code, can further take into consideration the timing of the scheduled production of the different products as dictated by the first production schedule in scheduling delivery times for one or more raw products consistent with the times needed for those raw products at the respective production lines to produce the products in accordance with the first production schedule.

The processing resource 102, in some embodiments, can additionally execute a semi-finished goods scheduling code set to schedule estimated semi-finished good production of one or more semi-finished goods as a function of the first production schedule, and in some implementations a quantity of each of the respective one or more semi-finished goods to be available prior to initiating production of a corresponding one of the products, of the multiple different products, to be produced from the respective one or more semi-finished goods. For example, the processing resource executing the semi-finished goods scheduling code set can schedule an estimated first semi-finished good production of a first semi-finished good as a function of the first production schedule and a quantity of the first semi-finished good available prior to initiating production of a corresponding first product using the first semi-finished good. The semi-finished goods scheduling enables the system to provide and utilize the semi-finished goods to produce the intended products at the scheduled production quantities and/or levels dictated by the first production schedule. The execution of the semi-finished goods scheduling code can further take into consideration finished goods on hand, state of quantities of semi-finished goods, already available raw products, and/or other such information, and typically the timing of the scheduled production of the different products as dictated by the first production schedule, in determining the scheduling of the semi-finished goods.

In some embodiments, the non-transitory machine readable medium stores a production materials scheduling code set. The processing resource 102, in executing this production materials scheduling code set, can schedule variable deliveries of one or more materials (e.g., bottles, labels, caps, packaging, etc.) over the scheduled period of time to satisfy the first production schedule as a function of inventory of the one or more materials and predicted usage of the one or more materials as a function of the first production schedule.

Based at least on the selected first production schedule, the processing resource 102 can control one or more system components 130 (e.g., pumps, conveyor systems, transport systems, heating and/or cooling systems, cutting systems, etc.) of the multiple production lines consistent with the selected first production schedule to implement production along the production lines of a respective one of the multiple different product according to the scheduled timing of the first production schedule. The production lines can include one or more control systems and/or circuits of the system components and/or coupled with the system components to control the operation of the system components 130. The control systems can include one or more transceivers and/or receivers to receive operating instructions, such as operating instructions from the processing resource 102 in controlling the one or more production lines within which the respective system component 130 is cooperated in producing the products in accordance with the selected production schedule. Further, in some implementations, the processing resource can control the scheduling and/or ordering of raw product(s), semi-finished good production, semi-finished good transport, materials (e.g., labels, bottles, packaging, etc.), and/or other such control over the operation of the one or more production facilities.

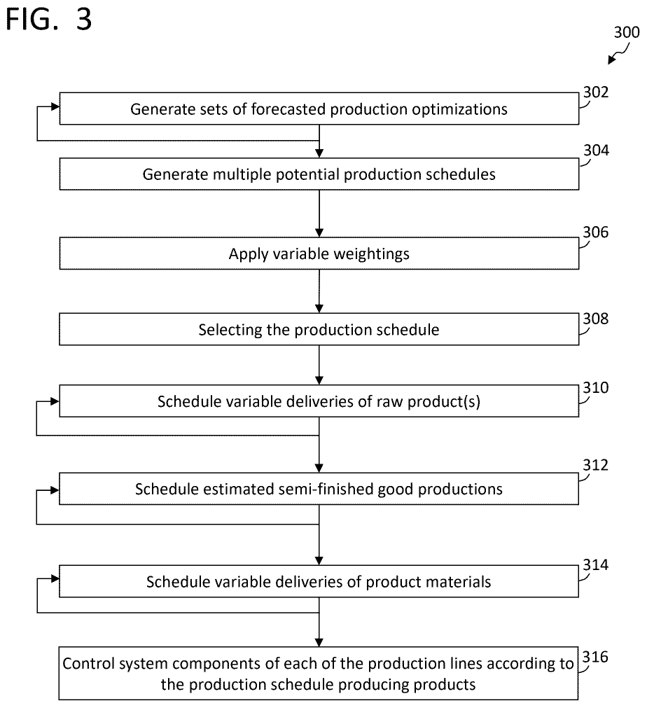

FIG. 3 illustrates a flow diagram of an example process 300 of controlling a production facility 204 in producing products via multiple production lines in controlling a production facility in producing multiple different products along multiple production lines, in accordance with some embodiments. In step 302, sets of forecasted production optimizations are generated by a processing resource 102 using a set of one or more first trained models that are applied relative to at least predicted product demand and production line data, relative to multiple objective constraints. comprising production line change over time, a maximum uptime limit for each of multiple production lines, and production line utilization. In some embodiments, the objective constraints can include one or more of constraints minimizing a production line change over time of the product lines, maximizing an uptime limit for each of the multiple production lines, maximizing the production line utilization of the multiple production lines, and maximizing semi-finished goods usage. The first trained model, in some embodiments, can be used, in some applications, to complying with a constraint of scheduling production of a first product, of the multiple different products, that has a lower quantity of finished goods to a production period of time of a daily production line operating duration that is subsequent to a scheduled production period of a second product of the multiple different products that has a second quantity of finished goods that is greater than the lower quantity of finished goods of the first product. The processing resource in generating the sets of forecasted production optimizations can use the first trained model relative to risks of expiration of previously produced and stored finished products (FP) of one or more of the multiple different products produced through the multiple production lines of the one or more production facilities. Further, in some embodiments, the sets of forecasted production optimizations are generated in compliance with governmental regulations, which can include for example, uptime operating limits of each of the multiple production lines.

In step 304, the processing resource 102, using a second trained model and the sets of forecasted production optimizations, can generate multiple potential production schedules of the multiple production lines over a scheduled period of time and that comply with the multiple objective constraints. Each of the multiple potential production schedules, in some implementations, can define schedules for multiple production days during which the multiple different products are produced as a function of the predicted product demand of the multiple different products while complying with the multiple objective constraints. Some embodiments include step 306, where the processing resource 102 can apply a set of one or more weightings to one or more of the object constraints. For example, some embodiments apply a first variable weightings to target changeover time of at least a first production line, of the multiple production lines, and second variable weightings to semi-finished goods usage.

In step 308, at least a first production schedule, of the multiple potential production schedules, is selected to be applied in controlling the multiple product lines of the one or more facilities that comply with the constraints and as a function of the forecasted production optimizations. Further, in some embodiments, the first production schedule can be selected as a function of the results of the application of one or more weightings, such as the first variable weightings and/or the second variable weightings. Some embodiments include step 310, where the selected first production schedule is used at least in part to schedule variable deliveries of one or more raw product (e.g., raw milk), used to produce at least a first product of the multiple different products, over the scheduled period of time to satisfy the first production schedule. Further, some embodiments include step 312, wherein the selected first production schedule is used to schedule estimated semi-finished goods production of one or more semi-finished goods, as a function of the first production schedule, and a quantity of the respective semi-finished good available (e.g., a first semi-finished good) prior to initiating production of a respective one or more products (e.g., a first product), of the multiple different products, that are to use the first semi-finished good in completing the production of the respective product. In some embodiments, the process 300 includes step 314 where the selected first production schedule is used to schedule variable deliveries of one or more materials (e.g., packaging, labels, lids, casings, etc.) over the scheduled period of time to satisfy the first production schedule as a function of inventory of the one or more materials and predicted usage of the one or more materials as a function of the first production schedule. In step 316, the processing resource 102 can automatically control one or more system components 130 of each of the multiple production lines according to the first production schedule implementing production of a respective one of the multiple different products consistent with the first production schedule. In some embodiments, each production line may include a line control circuit that receives instructions and/or schedules of instructions from the processing resource to be executed in complying with the selected first production schedule through the control of one or more components 130, and/or system components 130 may include control circuits that can receive and execute one or more instructions in executing the first production schedule.

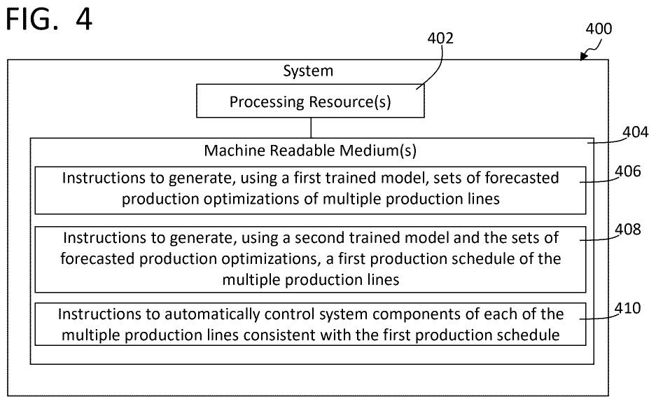

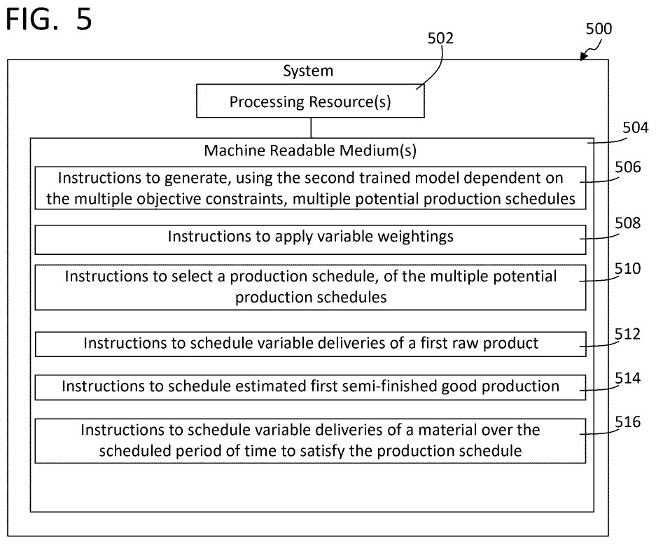

FIGS. 4-5 depict example systems 400, 500, respectively, that includes one or more non-transitory, machine readable media 404, 504 encoded with example instructions and/or one or more sets of code executable by one or more electronic processing resources 402, 502, respective, in accordance with some embodiments. In some embodiments, the systems 400, 500 may be useful for implementing aspects of the production facility control system 100 and/or the one or more processing resources 102, and/or in performing some or all aspects of the process 300 of FIG. 3. For example, the instructions encoded on machine readable media 404 and/or 504 may be included in instructions 106. In some implementations, functionality described with respect to FIG. 3 may be included in the instructions encoded on machine readable media 404 and/or 504.

The one or more processing resources 402, 502 may include a microcontroller, a microprocessor, central processing unit core(s), an ASIC, an FPGA, and/or other hardware device suitable for retrieval and/or execution of instructions from the machine readable media 404, 504 to perform functions related to various examples. Additionally or alternatively, the processing resources 402, 502 may include or be coupled to electronic circuitry or dedicated logic for performing some or all of the functionality of the instructions described herein.

The machine readable media 404, 504 may be any medium suitable for storing executable instructions, such as RAM, ROM, EEPROM, flash memory, a hard disk drive, an optical disc, or the like. In some example implementations, the machine readable media 404, 504 may be a tangible, non-transitory medium. The machine readable media 404, 504 may be disposed within the system 400, 500, respectively, in which case the executable instructions may be deemed installed or embedded on the system. Additionally or alternatively, some or all of the machine readable media 404, 504 may be one or more remote, external to and/or portable storage medium, and may be part of an installation package.

As described further herein, the machine readable media 404, 504 may be encoded with a set of executable instructions. It should be understood that part or all of the executable instructions and/or electronic circuits included within one box may, in alternate implementations, be included in a different box shown in the figures or in a different box not shown. Some implementations may include more or fewer instructions than are shown in FIGS. 4 and 5.

With reference to FIG. 4, the machine readable media 404 includes instructions 406, 408, 410. Further, in some embodiments, the instructions are executed during a current session with a user computing device 110. Instructions 406, when executed, cause the processing resource 402 to generate, using a first trained model in controlling a production facility in producing multiple different products, sets of forecasted production optimizations of multiple production lines in producing the multiple different products. The first trained model can use, in some implementations, predicted product demand and production line data, relative to multiple objective constraints comprising production line change over time, a maximum uptime limit for each of multiple production lines, and production line utilization. Instruction 408, when executed, cause the processing resource 402 to generate, using a second trained model and the sets of forecasted production optimizations of the multiple production lines, a first production schedule of the multiple production lines over a scheduled period of time comprising multiple production days to produce the multiple different products as a function of the predicted product demand of the multiple different products while complying with multiple objective constraints. Instruction 410, when executed, cause the processing resource 402 to automatically control system components of each of the multiple production lines implementing production of a respective one of the multiple different products consistent with the first production schedule.

In some embodiments, the generation of the sets of forecasted production optimizations of the multiple production lines can use the first trained model relative to the multiple objective constraints comprising minimizing the production line change over time, the maximum uptime limit for each of the multiple production lines, maximizing the production line utilization of the multiple production lines, and maximizing semi-finished goods usage. The generation of the sets of forecasted production optimizations of the multiple production lines can, in some embodiments, use the first trained model relative to risks of expiration of previously produced and stored finished products of one or more of the multiple different products. In some embodiments, the generation of the sets of forecasted production optimizations of the multiple production lines can use the first trained model relative to the multiple objective constraints comprising complying with governmental regulations of uptime operating limits of each of the multiple production lines. In some embodiments, the generation of the sets of forecasted production optimizations of the multiple production lines can use the first trained model relative to the multiple objective constraints comprising complying with a constraint of scheduling production of a first product, of the multiple different products, that has a lower quantity of finished goods to a production period of time of a daily production line operating duration that is subsequent to a scheduled production period of a second product of the multiple different products that has a second quantity of finished goods that is greater than the lower quantity of finished goods of the first product.

With reference to FIG. 5, the machine readable media 405 includes instructions 506, 508, 510, 512, 514, 516. Further, in some embodiments, the instructions are executed during a current session with a user computing device 110. Instructions 506, when executed, cause the processing resource 502 to generate, using the second trained model dependent on the multiple objective constraints, multiple potential production schedules, comprising the first production schedule, of the multiple production lines over the scheduled period of time. Instruction 508, when executed, cause the processing resource 502 to apply first variable weightings to target changeover time of a first production line of the multiple production lines and second variable weightings to semi-finished goods usage. Instruction 510, when executed, cause the processing resource 502 to select the first production schedule, of the multiple potential production schedules, as a function of the first variable weightings and the second variable weightings. Instruction 512, when executed, cause the processing resource 502 to schedule variable deliveries of a first raw product, used to produce at least a first product of the multiple different products, over the scheduled period of time to satisfy the first production schedule. Instruction 514, when executed, cause the processing resource 502 to schedule estimated first semi-finished good production of a first semi-finished good as a function of the first production schedule and a quantity of the first semi-finished good available prior to initiating production of a first product, of the multiple different products, using the first semi-finished good. Instruction 516, when executed, cause the processing resource 502 to schedule variable deliveries of a first material over the scheduled period of time to satisfy the first production schedule as a function of inventory of the first material and predicted usage of the first material as a function of the first production schedule.

The present embodiments can be utilized to control production facilities in producing substantially any relevant products. As one non-limiting example, the production facility control system 100 can be used in some embodiments as a dairy facility control system providing material requirement planning (iMRP) application that develops a comprehensive planning and procurement specifically tailored for a dairy product production facility. The multi-layer production scheduling operation provided by the processing resource 102 using the sequential application of the first and second machine learning models to generate a production schedule for milk product finished goods (e.g., Skim, 1%, 2%, Whole, Chocolate), semi-finished goods (SFG), and raw production materials (RM) (e.g., bottles, labels, caps etc.) by maximizing line utilization, SFG usage, meeting inventory targets, and satisfying store demand. The production facility control system 100 provides advanced planning and visibility spanning a production period of time, which in some instances can be over multiple weeks (e.g., 2, 3, 4, 6, etc.) and serves as a valuable resource for both facility operators (for FG and SFG schedules) and the control of procurement (e.g., for RM schedule) at the dairy production facility. The application of the generated product schedule in controlling the production of products via the multiple lines can maintain stock percentages at one or more predefined threshold levels (e.g.,, approximately 95%). The control of the production improves productions to meet demands at one or more retail facilities selling the produced milk products, thus increasing customer satisfaction, such as by attaining substantially a 100% In Stock percentage, and meeting demand across one or more retail stores. Further, in some embodiments, the production facility control system 100 can decrease the cost-per-unit by enhancing productivity, thereby leading to significant cost savings.

In some embodiments, for example, the selected production schedule can provide at least in part a weekly finished goods (FG) schedule, which may provide for example an hourly forecast for each production line of the multiple production lines of a facility. As described above, based on the selected production schedule and predicted production, the processing resource can execute raw product scheduling code set to subsequently develop one or more raw product schedules dictating the scheduling of the delivery of raw products (e.g., scheduling the number of raw product quantity and/or trucks to be ordered daily). In some embodiments, one or more users may access an initial first selected production schedule through a respective user computing device (e.g., computer, laptop, tablet, smartphone, etc.) and potentially modify the selected production schedule, which is typically based on knowledge unknown and/or unavailable for the production facility control system 100. The user-edited production schedule can be stored (“frozen”) as a finalize production schedule for implementation. The user-edited production schedule can then form the basis for use by the processing resource in determining additional scheduling, such as but not limited to semi-finished goods (SFG) scheduling, which in some instances can detail start and end times and the quantities of SFG desired, raw product scheduling, indicating a quantity (e.g., raw count, raw volume, etc.) of raw product and input products to satisfy the expected quantities finished goods of the one or more products expected to be produced according to the user-edited production schedule.

The production facility control system 100, in some embodiments, can generate the set of one or more production schedules based on the sets of forecasted production optimizations generated through the first trained model consistent with one or more parameters, and generate the scheduling using the forecasted production optimizations using the second trained model as a function of predefined constraints. Some constraints can include: changeover time (C/O) corresponding to a time taken to switch a line from a production of a first product (e.g., Gallon) to a second product (e.g., half gallon); a setup time corresponding to a time to setup a production line for operation (e.g., for a dairy product facility, plant the setup time may not be as significant as the changeover time, or a cleaning times), as compared to other types of production facilities; a cleaning time which may include two or more cleaning types (e.g., master sanitation schedule (MSS) providing a deep cleaning that may occur periodically on the production lines, a cleaning-in place (CIP) cleaning that takes place when switching between products (e.g., high fat FGs to low fat FGs, chocolate FGs to a non-chocolate FGs, and/or a time occurring when the line uptime reaches a cycle uptime limit); planned downtimes that may be down for general downtime, maintenance down times, idle downtimes, MSS cleaning times, CIP cleaning times, etc.; cycle uptime limit by line with production lines complying with predefined run cycles (e.g., in a dairy production facilities runs may be in cycles for three lines of, for example, 36 hours, 36 hours, and 24 hours for Lines 1, 2 & 3, respectively, with the uptime corresponding to total hours the line is running continuously without any significant downtime); other cleaning times, such as a mandatory CIP assigned when an uptime limit is reached and an uptime resets back to zero; an expiry which may be daily or other period of time, and correspond to the quantity of FGs that are at risk of expiry are calculated and the production target can be adjusted accordingly to prevent expiry in the future.

As described above, the processing resource 102 can in some embodiments generate scheduling in controlling the management of raw product and/or production material strategies. The generated scheduling can provide for an inventory sensitive dynamic finished good prioritization. For example, with a milk product production facility, the machine learning models may use and/or dictate a weighting of products that have less semi-finished goods (SFG) inventory on a particular day to be produced later in the day. In some applications, when the scheduling provides for the production of one or more products that have less SFG inventory, then SFG slots can be allocated to allow enough time to complete processing (e.g., complete pasteurization). The application of the models can, in some embodiments, further factor in days on hand inventory, that may provide priority to producing one or more products with fewer days on hand inventory for a current or forecasted day. Again, the application of the trained models take into consideration of uptime limit constraints. For example, the production schedule can take into consideration planned downtimes (e.g., changeover time, cleaning time, etc.), while further evaluating relative to other limits such as line uptime limits (e.g., dairy production may limit line operations to cycle durations (e.g., 36, 36 & 24 hours for lines 1, 2 & 3) to comply with governmental regulations. In some embodiments, further constraints can take into consideration delivery strategies, which may include expiration predictions of products, which may cause an adjust of the target stock levels.

In some embodiments, the production facility control system 100 can apply one or more trained models that utilize scalable hierarchical model decomposition via the two-layered strategy. The first trained model, for example, can apply a non-dominated sorting genetic algorithm (e.g., NSGA-Ill) for production, and the second trained model can implement one or more simulated annealing algorithms in scheduling. This dual-layer approach offers feasible solutions within acceptable computation times, providing scalability for manufacturing facilities with multiple products and production lines. The hierarchical decomposition can divide the scheduling issues into two manageable subproblems, and changes can be addressed through recalculation of the relevant subproblem, enhancing the model's efficiency and scalability.

The processing resource 102, in using the first and second trained models, can in some embodiments use the trained models relative to historic data, current data and forecasted data, such as but not limited to historic and future capacity, end to end yield data, raw and semi-finished goods inventory, finished goods inventory, finished goods demand forecasting. The processing resource and provide procurement visibility (e.g., daily optimal raw product needed (e.g., raw milk), optimal production materials (e.g., labels, bottles, caps, cartons, etc.), historic and/or forecasted raw product orders, etc.). Further, the production facility control system 100 can provide production line visibility (e.g., forecasted capacity, production schedule, adherence and attainment data, daily production plan, etc.). Still further, in some embodiments the production facility control system 100 can provide enhanced inventory visibility (e.g., days on hand finished goods inventory, expiry risk count, etc.).

The production facility control system 100, in some embodiments can use a Meta-Heuristics Algorithm (MHA) to generate the production schedule that can attempt to maximize an ending inventory to target stock level ratio, maximize semi-finished goods (SFG) usage, minimize changeover and cleaning times, and maximize line utilization while complying with multiple constraints, such as line uptime limit(s) and/or other constraints. Resulting production schedules can both maintain sufficient inventory (e.g., in a warehouse) and meet demand (e.g., daily demand from one or more entities, such as but not limited to distribution centers, stores, suppliers, distributors, etc.) for a predefined future period of time (e.g., an upcoming four weeks). In some embodiments, the production facility control system 100 can comprise a production layer that provides a list of solutions based on one or more objective constraints or functions (e.g., minimize target deviation, minimize changeover & cleaning time, maximize line utilization & maximize semi-finished goods (SFG) usage) while considering downtime (e.g., master sanitation schedule (MSS), cleaning-in place (CIP), planned downtimes, etc.) and target stock constraints.

For example, some embodiments can utilize the following example constraints:

$$Minimize : {F}_{1} = ( ( {\sum }_{i = 1}^{N} \vert ( {B}_{i} + {\sum }_{j = 1}^{M} ( {x}_{ij} \times {r}_{ij} ) - {D}_{i} ) - {T}_{i} \vert / {T}_{i} ) * ( \frac{1}{{doh}_{i}} ) )$$

$$Minimize : {F}_{2} = {\sum }_{j = 1}^{M} ( {C}_{last - first , j} + {\sum }_{i = 1}^{N} {\sum }_{k = 1}^{N} {C}_{ijk} \times {y}_{ijk} )$$

$$Maximize : {F}_{( 3 , 4 , 5 )} = \frac{{\sum }_{i = 1}^{N} {x}_{ij}}{{H}_{j}} ∀ j ∈ \{ 1 , … , M \}$$

$$Maximize : {F}_{6} = {\sum }_{j = 1}^{M} {\sum }_{i = 1}^{N} min ( \frac{( {x}_{ij} \times {r}_{ij} )}{{\partial }_{{sfg \_ fg}_{i}}} , I ( {sfg}_{i} ) )$$

$$S . T .$$

$$( {\sum }_{i = 1}^{N} {x}_{ij} + {C}_{last - first , j} + {\sum }_{i = 1}^{N} {\sum }_{k = 1}^{N} {C}_{ijk} \times {y}_{ijk} \leq {H}_{j} ) ∀ j ∈ \{ 1 , … , M \}$$

$$( {x}_{ij} = 0 ) \vert ( {x}_{ij} \geq 3 ) ∀ i ∈ \{ 1 , … , N \} , ∀ j ∈ \{ 1 , … , M \}$$

$$( {B}_{i} + {\sum }_{j = 1}^{M} ( {x}_{ij} \times {r}_{ij} ) - {D}_{i} ) \leq {T}_{i} ∀ i ∈ \{ 1 , … , N \}$$

$${\sum }_{i = 1}^{N} ( {\sum }_{j = 1}^{M} \frac{( {x}_{ij} \times {r}_{ij} )}{{\partial }_{{sfg \_ fg}_{i}} \times {\partial }_{{rm \_ sfg}_{i}}} ) \leq {\sum }_{i = 1}^{N} \frac{I ( {sfg}_{i} )}{{\partial }_{{rm \_ sfg}_{i}}} + R$$

$${T}_{i} = max ( 1 , ( {T}_{{i}^{′}} - {ROE}_{i} ) )$$

where:
F1: Objective function to minimize a total deviation between ending inventory and production targets for the multiple products (finished goods (FG));
F2: Objective function to minimize the total changeover and cleaning times for a period (e.g., a day);
F(3,4,5): Objective function to maximize the line utilization across the multiple production lines (e.g., three production lines: Lines 1, 2 and 3); and
F6: Objective function to maximize the semi-finished goods (SFG) usage for a period of time (e.g., a day);
   with decision variables:
xᵢⱼ: Production hours for product i in line j; and
yᵢⱼₖ: Binary variable that equals 1 if the product i is produced before the product k in line j, with this value defined from a simulated anneal loop;
   with function mapping and constants according to:
N: Total number of products (FGs);
M: Total number of product lines;
Bᵢ: Beginning inventory for product i;
rᵢⱼ: Production rate for product i in line j;
∂_{rm_sfg}i: The yield for converting raw product (e.g., milk) to a semi-finished good used for a product (FG) i while considering quantity lost during processing (e.g., pasteurization);
∂_{sfg_fgi}: The yield while considering quantity lost during production processing (e.g., filling) from SFG to product i;
S: Set of all products (FGs);
G: Set of all semi-finished products (SFG);
Q: Function mapping FGs to SFGs;
fgᵢ: Finished product i (fgᵢ∈S);
sf gᵢ: semi-finished good (SF) for producing a finished good (FG) i (sfgᵢ=Q(fgᵢ), sfgᵢ∈G);
I(sf gᵢ): SFG inventory for product i in storage (e.g., silos) for a period of time (e.g., first day);
R: Total raw product (e.g., milk) inventory in storage (e.g., silos) plus expected raw product quantity to receive for a period (e.g., first day);
Dᵢ: Demand for product i;
Tᵢ: Production targe for product i after considering risk of expiry quantity;
ROEᵢ: Risk of expiry for product i;
Tᵢ: Production targe for product i before considering risk of expiry quantity;
dohᵢ: Ending inventory days on hand for product i;
Cᵢⱼₖ: Total changeover and cleaning time when switching from product i to product k in line j;
C_{last-first,j}: Total change over and cleaning time when switching from last day product to current day's first product in line j; and
Hⱼ: Productive hours available for line j.

In some embodiments, the facility control system 100 can implement a scheduling layer applying the second trained model. In some embodiments, the scheduling layer can operate at least in part based on:
While T>T_{Final}:
   Generate new sequence S′ by swapping two products at a time in original sequence S. Then compute the new energy E(S′) if UL(S′)<ULₘₐₓ(S):

$$if E ( {S}^{′} ) < E ( S ) :$$

$$S , E ( S ) = {S}^{′} , E ( {S}^{′} )$$

$$elif random value {e}^{\frac{E ( S ) - E ( {S}^{′} )}{T}} :$$

$$S , E ( S ) = {S}^{′} , E ( S )$$

$$T = T * C ; and$$

where

Some embodiments can implement a pre-processing layer to consider raw product data (e.g., raw milk and SFG inventory silo levels, SFG and FG Yield, BOM, etc.), production line operating data (e.g., FG production rates, current line uptime, last run FG on each line, changeover, cleaning and user downtimes, etc.), warehouse data (e.g., FG beginning inventory, safety stock levels), delivery data (e.g., FG demand), and/or other such data and/or preprocessing to obtain such data. As described above, some embodiments employ a multi-layer application (e.g., a production layer, and a scheduling layer) based in part on the application of trained models. In the production layer, some embodiments utilize an NSGA-Ill algorithm with multiple objective constraints (e.g., minimize target deviation, minimize changeover and cleaning time, maximize each line utilization (e.g., lines 1, 2, 3) and maximize SFG usage, etc.) while considering product line constraints (e.g., available productive hours, short production (produce for a minimal X time (e.g., 3 hours)), excess inventory (e.g., over maximum safety stock level), raw milk availability (e.g., for a given period (e.g., first day)), stock keeping unit (SKU) prioritization (e.g., FGs with less days on hand inventory may be given more weightage to produce), risk of expiry (e.g., if there are some FGs with expiry then the production target may be adjusted accordingly). In the scheduling layer, some embodiments obtain a near-optimal production schedule of finished goods that comply with the constraints (e.g., have less total changeover and cleaning time, and the generated sequence does not exceed the maximum uptime limit for the line). Some embodiments may further optimize the scheduling by producing multiple potential production schedules, and post processing can evaluate the multiple potential production schedules. For example, an optimization can apply one or more weightings, such as selecting a best solution based on a weighted average of objective constraints (e.g., Day 1: 70% weightage to Target Deviation, 2% weightage to Changeover & Cleaning Time, 7% weightage to each Line Utilization, 7% weightage to SFG Usage). A selected production scheduling can schedule an allocation of planned user downtimes (e.g. maintenance downtime) within a scheduled duration (e.g., 28 days×24 hours x 3 production lines template). Remaining available time periods (e.g., hourly slots) can in some embodiments be allocate while considering CIPs, such as transitioning product lines from one product to another product for changeovers (e.g., high fat to low fat FGs, Chocolate to non-chocolate FGs, etc.) and allocating CIPs when uptime limit is reached in each production line. In some embodiments, the scheduling can consider previous days and/or initial days, such as for a first day, when the selected production schedule starts with products (FGs) that have less SFG Inventory (e.g., in the silos), then corresponding SFG slots and/or processing slots (e.g., pasteurization slots (e.g. “PT-Stnd 2% Milk”)) can be allocated before starting the product production. Some embodiments further consider constraints such as an approximate ending inventory to safety stock ratio (End Inv. To SS) for each product (FGs) (FGs with less End Inv. To SS may be given priority to be produced earlier in a production cycle, e.g., earlier in a day).

The processing resource 102, in executing the instructions 106, can in some embodiments further implement data monitoring that can implement one or more sets of rule-based validation checks to try and detect data that is abnormal, beyond one or more thresholds, is missing, available, other such anomalies, or a combination of two or more of such anomalies. In response to detecting a data anomaly, the processing resource can control a notification system that can generate and/or communicate one or more anomaly notifications and/or warnings. For example, the processing resource in some embodiments can control an email system to automatically generate and communicate one or more emails to one or more predefined intended recipients as a function of the type of anomaly, wirelessly communicate a warning notice and/or notification of the anomaly to one or more intended recipients (e.g., via a text message, audio message, etc.), generate a log report, and/or control one or more other such communication systems.

As described above, the processing resource can generate a raw product schedule, in some embodiments through a pre-processing layer, for the acquisition, delivery and/or use of one or more raw product(s) (e.g., raw milk from a dairy) for use in the production of one or more products through one or more of the production lines. The raw product scheduling can be implemented to provide variable deliveries of one or more raw products (e.g., raw milk), used to produce at least a first product of the multiple different products, over the scheduled period of time to satisfy the selected first production schedule. This raw product scheduling can, with a milk production example, provide an optimal number of deliveries (e.g., trucks and/or volume of raw milk) intended to be used for each of at least one and typically multiple sequential production periods (e.g., each day), and while may reduce weekly variance. The raw product scheduling can in some embodiments utilize:

$$Minimize : {\sum }_{i = 1}^{{n}_{days} - 1} {( {V}_{i} - {V}_{i - 1} )}^{2}$$

$${E}_{i} = {B}_{i} + {V}_{i} - {P}_{i} , ∀ i ∈ \{ 0 , … , {n}_{days} - 1 \}$$

$${B}_{i} = {E}_{i - 1} , ∀ i ∈ \{ 1 , … , {n}_{days} - 1 \}$$

### Where,

Vᵢ: Truck volume on day i, 0≤Vᵢ≤n_{max trucks}×C_{truck};
Bᵢ: Beginning silo inventory on day i, 0≤Bᵢ≤n_{raw milk silo}×C_{raw milk silo};
Eᵢ: Ending silo inventory on day i, 0≤Eᵢ≤n_{raw milk silo}×C_{raw milk silo};
Pᵢ: Production quantity on day i;
n_{days}: Total number of days;
n_{raw milk silo}: Total number of raw milk silos;
n_{max trucks}: Maximum number of trucks that can be scheduled in a day;
C_{raw milk silo}: Maximum capacity of each raw milk silo in gallons; and
C_{truck}: Maximum capacity of each truck in gallons.

The processing resource 102, in executing the instructions, in some embodiments can generate a semi-finished goods (SFG) schedule based on the selected first production schedule. The SFG scheduling can schedule estimated semi-finished goods production and/or use of one or more semi-finished goods, and a quantity of the respective semi-finished good available (e.g., a first semi-finished good) prior to initiating production of a respective one or more products (e.g., a first product) of the multiple different products, that are to use the first semi-finished good in completing the production of the respective product.

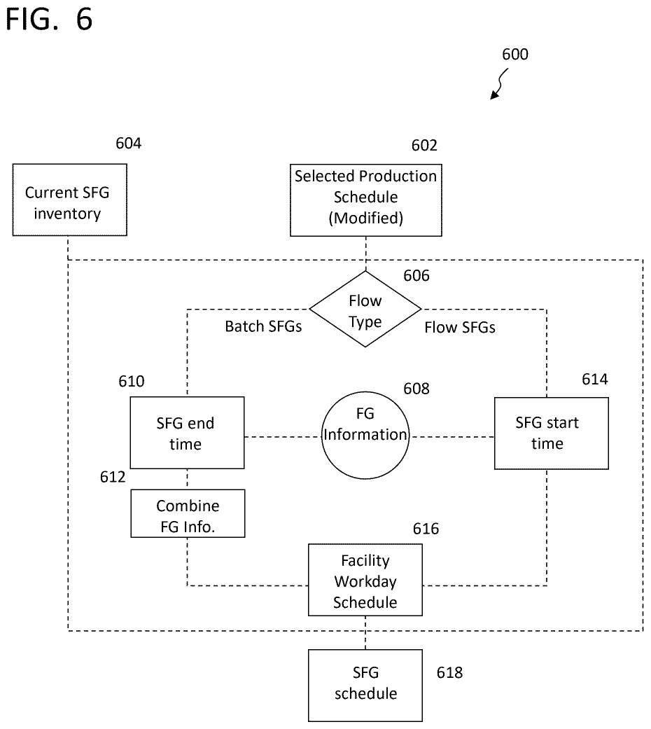

FIG. 6 illustrates a functional diagram of an example semi-final goods scheduling process 600, in accordance with some embodiments. The semi-finished goods (SFG) schedule 618 can greatly improve the control of the production facility and production process, providing in part one or more of an estimated SFG production quantity, start time, and end time to follow the selected first production schedule. In a milk product example, the semi-finished goods schedule can include scheduling for pasteurizing milk from raw milk silos to SFG silos (e.g., via one or more high temperature short time (HTST) lines). Current SFG inventory 604 (current SFG silo levels) can be calculated, for example by aggregating the levels for the multiple pasteurization tanks. Furthermore, the SFG consumption can be constructed based on the selected first product schedule 602 (or final production schedule when a user modifies the selected first production schedule). The processing resource 102, in some embodiments can consider 606, for example, an SFG type (e.g., batch type SFGs, and flow type SFGs.), relative to the selected first production schedule 602 (or the modified schedule of modified). Based on the first production schedule information 608, the batch type SFGs, for example, can have a SFG end time 610 (x) providing for the semi-finished goods to be ready a scheduled time and/or a threshold period prior to starting production of a corresponding product (FG). For instance, chocolate's SFG end time can be set 3 hrs. before finished (FG) start time (x=3), and skim, 1% s SFG end times can be 2 hrs. before FG start time (x=2). Batch flow type FGs can be produced in fixed quantities, for example, a few days apart. If these occur on consecutive days, some embodiments can combine 612 these to simplify the scheduling. The flow type SFGs can, for example, have an SFG start time 614 to commence a second predefined period (e.g., 2 hours) before the associated FG production. For example, an SFG start time of two hour prior to FG start time can be used with 2% milk product(s), whole milk product(s). An adjusted SFG schedule can be fine-tuned, for example, based on the current SFG silo levels and adjusted to match the production facility workday schedule 616 (e.g., from 5:30 AM today to 5:30 AM the next day).

In some embodiments, the processing resource 102 in executing the instructions 106 can generate one or more production materials scheduling of production materials (e.g., packaging, labels, lids, casings, etc.) based on the selected first production schedule (or user modified first production schedule). The production materials schedule can, in part, schedule variable deliveries of the one or more over the scheduled period of time to satisfy the first production schedule as a function of inventory of the one or more production materials and predicted usage of the one or more production materials. The production material schedule can provide, in some embodiments, daily for comprehensive production material management, including inventory, orders, projected usage, and crucial metrics for planning and inventory control. Each period of time (e.g., a day), the processing resource 102 can collate data about the production material inventory, approximate production material consumption from the final product schedule (e.g., the weekly schedule that contains any user defined changes) and incoming purchase orders (PO). This data can provide the base of the production material scheduling that when executed can prevent potential delays due to material shortages and aiding in supply chain management. Example, production materials can include various types of labels, caps, bottles, containers, nutritional additives (e.g., Vitamin D3 and Vitamins A&D), flavoring agents (e.g., cocoa mix), liquid sugar, Resin and White Colorant, other such production materials, or a combination of two or more such production materials. Further, the production material scheduling can provide a projection of future production material consumption based on the final production schedule, enabling the system forward-looking insights into potential material excesses and shortages. Critical metrics such as inventory adequacy, projected runout dates, and average weekly consumption can be updated using the consolidated data from incoming orders and the production material forecasting, production material status that can be used in controlling effective inventory management and decision-making regarding supply chain and production planning.

The production facility control system 100 improves production efficiency, while more effectively complying with demand (e.g., On-Time In-Full (OTIF)), and achieving enhanced adherence to purchase orders. Further, the automated product schedule generation and/or production control according to the generated production schedule can enable increased throughput enabling enhanced capacity and increased profit margins. Further, the production facility control system 100 reduces the expiry of products, can minimize finished goods stockouts, reduce raw product material and semi-finished goods wastage, and lower manufacturing costs through production schedule optimization.

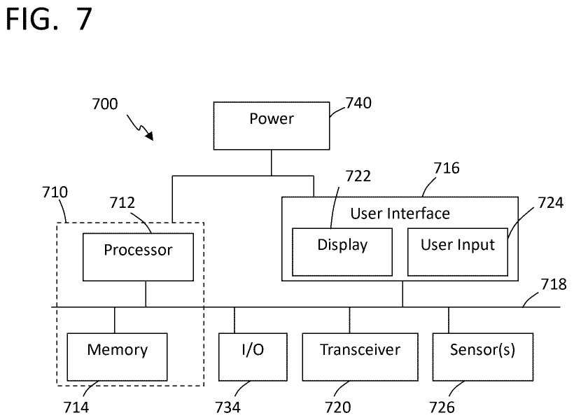

Further, the circuits, circuitry, systems, devices, processes, methods, techniques, functionality, services, servers, sources and the like described herein may be utilized, implemented and/or run on many different types of devices and/or systems. FIG. 7 illustrates an example system 700 that may be used for implementing any of the components, processing resources, circuits, circuitry, systems, functionality, logic, apparatuses, processes, and/or devices of the facility control system 100, processing resource 102, user computing devices 110, system components 130, control circuits, controllers, and/or other above or below mentioned systems or devices, or parts of such circuits, circuitry, functionality, systems, apparatuses, processes, or devices. However, the use of the system 700 or any portion thereof is certainly not required.

By way of example, the system 700 may comprise one or more control circuits or processor modules 712, one or more memory 714, and one or more communication links, paths, buses or the like 718. Some embodiments may include one or more user interfaces 716, and/or one or more internal and/or external power sources or supplies 740. The control circuit 712 can be implemented through one or more processors, microprocessors, central processing unit, logic, local digital storage, firmware, software, and/or other control hardware and/or software, and may be used to execute or assist in executing the steps of the processes, methods, functionality and techniques described herein, and control various communications, decisions, programs, content, listings, services, interfaces, logging, reporting, etc. Further, in some embodiments, the control circuit 712 can be part of control circuitry and/or a control system 710, which may be implemented through one or more processors with access to one or more memory 714 that can store instructions, code and the like that is implemented by the control circuit and/or processors to implement intended functionality. In some applications, the control circuit and/or memory may be distributed over a communications network (e.g., LAN, WAN, Internet) providing distributed and/or redundant processing and functionality. Again, the system 700 may be used to implement one or more of the above or below, or parts of, components, circuits, systems, processes and the like.

The user interface 716 can allow a user to interact with the system 700 and receive information through the system. In some instances, the user interface 716 includes a display 722 and/or one or more user inputs 724, such as buttons, touch screen, track ball, keyboard, mouse, etc., which can be part of or wired or wirelessly coupled with the system 700. Typically, the system 700 further includes one or more communication interfaces, ports, transceivers 720 and the like allowing the system 700 to communicate over a communication bus, a distributed computer and/or communication network 101 (e.g., a local area network (LAN), the Internet, wide area network (WAN), etc.), communication link 718, other networks or communication channels with other devices and/or other such communications or combination of two or more of such communication methods. Further the transceiver 720 can be configured for wired, wireless, optical, fiber optical cable, satellite, or other such communication configurations or combinations of two or more of such communications. Some embodiments include one or more input/output (I/O) ports 734 that allow one or more devices to couple with the system 700. The I/O ports can be substantially any relevant port or combinations of ports, such as but not limited to USB, Ethernet, or other such ports. The I/O interface 734 can be configured to allow wired and/or wireless communication coupling to external components. For example, the I/O interface can provide wired communication and/or wireless communication (e.g., Wi-Fi, Bluetooth, cellular, RF, and/or other such wireless communication), and in some instances may include any known wired and/or wireless interfacing device, circuit and/or connecting device, such as but not limited to one or more transmitters, receivers, transceivers, or combination of two or more of such devices.

In some embodiments, the system 700 may include and/or be in communication via the network 101 with one or more sensors 726 to provide information to the system 700 and/or sensor information that is communicated to another component, such as the processing resource 102, user computing devices 110, delivery vehicles, inventory systems, etc. The sensors can include substantially any relevant sensor, such as optical-based scanning sensors to sense and read optical patterns (e.g., bar codes), radio frequency identification (RFID) tag reader sensors capable of reading RFID tags in proximity to the sensor, distance measurement sensors (e.g., optical units, sound/ultrasound units, etc.), GPS sensor, accelerometer, light sensor, image capture system and image processing, heat sensors, level and/or weight sensors, and/or other such sensors. The foregoing examples are intended to be illustrative and are not intended to convey an exhaustive listing of all possible sensors. Instead, it will be understood that these teachings will accommodate sensing any of a wide variety of circumstances in a given application setting.

The system 700 comprises an example of a control and/or processor-based system with the control circuit 712. Again, the control circuit 712 can be implemented through one or more processors, controllers, central processing units, logic, software and the like. Further, in some implementations the control circuit 712 may provide multiprocessor functionality.

The memory 714, which can be accessed by the control circuit 712, typically includes one or more processor-readable and/or computer-readable media accessed by at least the control circuit 712, and can include volatile and/or nonvolatile media, such as RAM, ROM, EEPROM, flash memory and/or other memory technology. Further, the memory 714 is shown as internal to the control system 710; however, the memory 714 can be internal, external or a combination of internal and external memory. Similarly, some or all of the memory 714 can be internal, external or a combination of internal and external memory of the control circuit 712. The external memory can be substantially any relevant memory such as, but not limited to, solid-state storage devices or drives, hard drive, one or more of universal serial bus (USB) stick or drive, flash memory secure digital (SD) card, other memory cards, and other such memory or combinations of two or more of such memory, and some or all of the memory may be distributed at multiple locations over the computer network 101. The memory 714 can store code, software, executables, scripts, data, content, lists, programming, programs, log or history data, user information, customer information, product information, and the like. While FIG. 7 illustrates the various components being coupled together via a bus, it is understood that the various components may actually be coupled to the control circuit and/or one or more other components directly.

The machine learning models can be implemented through one or more machine learning models and/or generative artificial intelligence (AI). Machine learning may involve training a model in a supervised or unsupervised setting. Machine learning can include models that may be trained to learn relationships between various groups of data. Machine learned models may be based on a set of algorithms that are designed to model abstractions in data by using a number of processing layers. The processing layers may be made up of non-linear transformations. These machine learning models and/or AI can be trained and retrained over time with one or more corpora of information and/or feedback. The corpora of information can include historic data, including the historic data described above, and current data acquired in real time and/or maintained over time based on numerous different production cycles. Still further, some embodiments utilize artificially generated training and/or re-training data. Such data can be generated to simulate one or more data production line data, demand, timing, other such information or a combination of two or more of such information. Further, the model training system, in some implementations, continues to acquire data and/or feedback over time to be incorporated into the model training data and used to repeatedly re-train one or more models over time to improve the effectiveness and/or accuracy of the machine learning algorithm models. Such information and/or feedback can include production rates, demand, yield, expiry rates, subsequent purchase orders, subsequent changes by users, control commands, and/or other such information. The training data can be dependent on the type of machine learning model or models employed. One or more of the machine learning models and/or modeling applications may include the trained, deep learning models that process the data. The learning models can be substantially any relevant modeling, and in some embodiments is developed, maintained, and/or executed by one or more third parties. In some embodiments, the trained learning models may include, but are not limited to, one or more decision trees, neural network machine learning models, one or more convolutional neural networks, one or more deep convolutional and recurrent neural networks, one or more feed forward neural networks, regression, clustering, and substantially any other relevant modeling and supporting applications, or combination of two or more of such machine learning models and/or algorithms to implement the modeling. Additionally or alternatively, the machine learning models can comprise dynamically learned behavior based on, for example, decision tree learning, association rule learning, inductive logic learning, support vector learning, cluster analysis learning, Bayesian network learning, and/or similarity and metric learning, and/or other such modeling.

Some embodiments provide systems comprising: a processing resource; a non-transitory machine readable medium operably coupled to the processing resource and storing executable instructions and operational data effective that, when executed by the processing resource, cause the processing resource to execute a multi-layer production scheduling operation of multiple production lines of a production facility producing multiple different products including to: generate, using a first trained model, sets of forecasted production optimizations of the multiple production lines in producing the multiple different products, wherein the first trained model uses one or more of predicted product demand and production line data, relative to multiple objective constraints comprising production line change over time, a maximum uptime limit for each of the multiple production lines, and production line utilization; generate, using a second trained model and the sets of forecasted production optimizations, a first production schedule of the multiple production lines over a scheduled period of time comprising multiple production days to produce the multiple different products as a function of the predicted product demand of the multiple different products while complying with the multiple objective constraints; and control one or more system components of the multiple production lines consistent with the first production schedule to implement production of a respective one of the multiple different products.

Some embodiments provide methods, comprising: generating, using a first trained model in controlling a production facility in producing multiple different products along multiple production lines, sets of forecasted production optimizations of the multiple production lines in producing the multiple different products, wherein the first trained model uses predicted product demand and production line data, relative to multiple objective constraints comprising production line change over time, a maximum uptime limit for each of multiple production lines, and production line utilization; generating, using a second trained model and the sets of forecasted production optimizations, a first production schedule of the multiple production lines over a scheduled period of time comprising multiple production days to produce the multiple different products as a function of the predicted product demand of the multiple different products while complying with the multiple objective constraints; and automatically controlling system components of each of the multiple production lines according to the first production schedule implementing production of a respective one of the multiple different products consistent with the first production schedule.

Further, some embodiments provide non-transitory machine readable mediums storing instructions that, when executed, cause one or more processing resources to: generate, using a first trained model in controlling a production facility in producing multiple different products, sets of forecasted production optimizations of multiple production lines in producing the multiple different products, wherein the first trained model uses predicted product demand and production line data, relative to multiple objective constraints comprising production line change over time, a maximum uptime limit for each of multiple production lines, and production line utilization; generate, using a second trained model and the sets of forecasted production optimizations of the multiple production lines, a first production schedule of the multiple production lines over a scheduled period of time comprising multiple production days to produce the multiple different products as a function of the predicted product demand of the multiple different products while complying with multiple objective constraints; and automatically control system components of each of the multiple production lines implementing production of a respective one of the multiple different products consistent with the first production schedule.

Those skilled in the art will recognize that a wide variety of other modifications, alterations, and combinations can also be made with respect to the above described embodiments without departing from the scope of the disclosure, and that such modifications, alterations, and combinations are to be viewed as being within the ambit of the inventive concept.

1. A system comprising:
a processing resource;
a non-transitory machine readable medium operably coupled to the processing resource and storing executable instructions and operational data effective that, when executed by the processing resource, cause the processing resource to execute a multi-layer production scheduling operation of multiple production lines of a production facility producing multiple different products including to:
generate, using a first trained model, sets of forecasted production optimizations of the multiple production lines in producing the multiple different products, wherein the first trained model uses one or more of predicted product demand and production line data, relative to multiple objective constraints comprising production line change over time, a maximum uptime limit for each of the multiple production lines, and production line utilization;
generate, using a second trained model and the sets of forecasted production optimizations, a first production schedule of the multiple production lines over a scheduled period of time comprising multiple production days to produce the multiple different products as a function of the predicted product demand of the multiple different products while complying with the multiple objective constraints; and
control one or more system components of the multiple production lines consistent with the first production schedule to implement production of a respective one of the multiple different products.

2. The system of claim 1, wherein the processing resource, when executing the executable instructions, cause the processing resource to generate, using the second trained model, multiple potential production schedules of the multiple production lines over the scheduled period of time, wherein the generated multiple potential production schedules comprise the first production schedule; and
wherein the non-transitory machine readable medium stores a final goods sequencing code set that when executed by the processing resource cause the processing resource to apply first variable weightings to target changeover time of a first production line of the multiple production lines and second variable weightings to semi-finished goods usage, and select the first production schedule, of the multiple potential production schedules as a function of the first variable weightings and the second variable weightings.

3. The system of claim 1, wherein the non-transitory machine readable medium stores a raw product scheduling code set that when executed by the processing resource cause the processing resource to schedule variable deliveries of a first raw product, used to produce at least a first product of the multiple different products, over the scheduled period of time to satisfy the first production schedule.

4. The system of claim 3, wherein the non-transitory machine readable medium stores a semi-finished goods scheduling code set that when executed by the processing resource cause the processing resource to schedule estimated first semi-finished good production of a first semi-finished good as a function of the first production schedule and a quantity of the first semi-finished good available prior to initiating production of a first product, of the multiple different products, using the first semi-finished good.

5. The system of claim 3, wherein the non-transitory machine readable medium stores a production materials scheduling code set that when executed by the processing resource cause the processing resource to schedule variable deliveries of a first material over the scheduled period of time to satisfy the first production schedule as a function of inventory of the first material and predicted usage of the first material as a function of the first production schedule.

6. The system of claim 1, wherein the processing resource, in generating the sets of forecasted production optimizations of the multiple production lines, generates the sets of forecasted production optimizations of the multiple production lines using the first trained model relative to the multiple objective constraints comprising minimizing the production line change over time, the maximum uptime limit for each of the multiple production lines, maximizing the production line utilization of the multiple production lines, and maximizing semi-finished goods usage.

7. The system of claim 6, wherein the processing resource, in generating the sets of forecasted production optimizations of the multiple production lines, generates the sets of forecasted production optimizations of the multiple production lines using the first trained model relative to risks of expiration of previously produced and stored finished products of one or more of the multiple different products.

8. The system of claim 6, wherein the processing resource, in generating the sets of forecasted production optimizations of the multiple production lines, generates the sets of forecasted production optimizations using the first trained model relative to the multiple objective constraints comprising complying with governmental regulations of uptime operating limits of each of the multiple production lines.

9. The system of claim 8, wherein the processing resource, in generating the sets of forecasted production optimizations of the multiple production lines, generates the sets of forecasted production optimizations using the first trained model in compliance with maximizing an ending inventory to a target stock level ratio, maximizing semi-finished goods usage, and minimizing the production line change over time.

10. The system of claim 6, wherein the processing resource, in generating the sets of forecasted production optimizations of the multiple production lines, generates the sets of forecasted production optimizations using the first trained model relative to the multiple objective constraints comprising complying with a constraint of scheduling production of a first product, of the multiple different products, that has a lower quantity of finished goods to a production period of time of a daily production line operating duration that is subsequent to a scheduled production period of a second product of the multiple different products that has a second quantity of finished goods that is greater than the lower quantity of finished goods of the first product.

11. A method, comprising:
generating, using a first trained model in controlling a production facility in producing multiple different products along multiple production lines, sets of forecasted production optimizations of the multiple production lines in producing the multiple different products, wherein the first trained model uses predicted product demand and production line data, relative to multiple objective constraints comprising production line change over time, a maximum uptime limit for each of multiple production lines, and production line utilization;
generating, using a second trained model and the sets of forecasted production optimizations, a first production schedule of the multiple production lines over a scheduled period of time comprising multiple production days to produce the multiple different products as a function of the predicted product demand of the multiple different products while complying with the multiple objective constraints; and
automatically controlling system components of each of the multiple production lines according to the first production schedule implementing production of a respective one of the multiple different products consistent with the first production schedule.

12. The method of claim 11, further comprising:
generating, using the second trained model dependent on the multiple objective constraints, multiple potential production schedules, comprising the first production schedule, of the multiple production lines over the scheduled period of time;
applying first variable weightings to target changeover time of a first production line of the multiple production lines and second variable weightings to semi-finished goods usage; and
selecting the first production schedule, of the multiple potential production schedules, as a function of the first variable weightings and the second variable weightings.

13. The method of claim 11, further comprising:
scheduling variable deliveries of a first raw product, used to produce at least a first product of the multiple different products, over the scheduled period of time to satisfy the first production schedule.

14. The method of claim 13, further comprising:
scheduling estimated first semi-finished good production of a first semi-finished good as a function of the first production schedule and a quantity of the first semi-finished good available prior to initiating production of a first product, of the multiple different products, using the first semi-finished good.

15. The method of claim 13, further comprising:
scheduling variable deliveries of a first material over the scheduled period of time to satisfy the first production schedule as a function of inventory of the first material and predicted usage of the first material as a function of the first production schedule.

16. The method of claim 11, wherein the generating the sets of forecasted production optimizations comprises generating the sets of forecasted production optimizations of the multiple production lines using the first trained model relative to the multiple objective constraints comprising minimizing the production line change over time, the maximum uptime limit for each of the multiple production lines, maximizing the production line utilization of the multiple production lines, and maximizing semi-finished goods usage.

17. The method of claim 16, wherein the generating the sets of forecasted production optimizations comprises generating the sets of forecasted production optimizations of the multiple production lines using the first trained model relative to risks of expiration of previously produced and stored finished products of one or more of the multiple different products.

18. The method of claim 16, wherein the generating the sets of forecasted production optimizations comprises generating the sets of forecasted production optimizations of the multiple production lines using the first trained model relative to the multiple objective constraints comprising complying with governmental regulations of uptime operating limits of each of the multiple production lines.

19. The method of claim 16, wherein the generating the sets of forecasted production optimizations comprises generating the sets of forecasted production optimizations of the multiple production lines using the first trained model relative to the multiple objective constraints comprising complying with a constraint of scheduling production of a first product, of the multiple different products, that has a lower quantity of finished goods to a production period of time of a daily production line operating duration that is subsequent to a scheduled production period of a second product of the multiple different products that has a second quantity of finished goods that is greater than the lower quantity of finished goods of the first product.

20. A non-transitory machine readable medium storing instructions that, when executed, cause a processing resource to:
generate, using a first trained model in controlling a production facility in producing multiple different products, sets of forecasted production optimizations of multiple production lines in producing the multiple different products, wherein the first trained model uses predicted product demand and production line data, relative to multiple objective constraints comprising production line change over time, a maximum uptime limit for each of multiple production lines, and production line utilization;
generate, using a second trained model and the sets of forecasted production optimizations of the multiple production lines, a first production schedule of the multiple production lines over a scheduled period of time comprising multiple production days to produce the multiple different products as a function of the predicted product demand of the multiple different products while complying with multiple objective constraints; and
automatically control system components of each of the multiple production lines implementing production of a respective one of the multiple different products consistent with the first production schedule.
